(19) United States
(12) Patent Application Publication
(10) Pub. No.: US 2006/0082927 A1
(43) Pub. Date: Apr. 20, 2006

(54) Head, head suspension assembly, and disk device provided with the same

(75) Inventor: Mitsunobu Hanyu, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/199,242

(22) Filed: Aug. 9, 2005

(30) Foreign Application Priority Data
Oct. 19, 2004 (JP) 2004-304518

(51) Int. Cl. G11B 5/60

(52) U.S. Cl. 360/235.8; 360/235.7; 360/235.6

(57) ABSTRACT

A slider of a head has a negative-pressure cavity formed in a facing surface, a leading step portion which protrudes from the facing surface and is situated on the upstream side of the negative-pressure cavity with respect to an air current, and a trailing portion which protrudes from the facing surface and is situated on the downstream side of the negative-pressure cavity. The trailing portion integrally has a base step portion, which has a given width in a first direction X, and a projection, which protrudes in the first direction from the base step portion toward the negative-pressure cavity. A proximal end of the projection on the base step portion side has a width smaller than that of the base step portion, and a length of the projection in the first direction accounting for about 18% or more of a length of the facing surface in the first direction.

### CROSS-REFERENCE TO RELATED APPLICATIONS

This application is based upon and claims the benefit of priority from prior Japanese Patent Application No. 2004-304518, filed Oct. 19, 2004, the entire contents of which are incorporated herein by reference.

### BACKGROUND OF THE INVENTION

1. Field of the Invention

This invention relates to a head used in a disk device, such as a magnetic disk device, a head suspension assembly provided with the head, and the disk device provided with the head suspension assembly.

2. Description of the Related Art

A magnetic disk device as a typical disk device comprises magnetic disks contained within a case, a spindle motor that supports and rotates the disks, magnetic heads for writing and reading data to and from the disks, and a carriage assembly that supports the heads for movement with respect to the disks. The carriage assembly is provided with rotatably supported arms and suspensions that extend from the arms. The magnetic heads are supported individually on the respective extended ends of the suspensions. Each magnetic head has a slider mounted on its corresponding suspension and a head portion on the slider. The head portion includes a reproducing element and a recording element that are used, respectively, to read and write data.

The slider has a facing surface that faces a recording surface of the magnetic disk. The slider is subjected by the suspension to a given head load that is directed toward a magnetic recording layer of the magnetic disk. When the magnetic disk device is actuated, an air current is produced between the rotating disk and the slider. Based on the principle of air fluid lubrication, a force to fly the slider above the recording surface of the disk acts on the facing surface of the slider. By balancing this flying force and the head load, the slider can be flown with a given gap above the recording surface of the magnetic disk.

The fly of the slider is found to be uniform without regard to the radial position on the magnetic disk. The rotational frequency of the disk is fixed, and its peripheral speed varies depending on the radial position. Since the magnetic head is positioned by a rotary carriage assembly, moreover, the skew angle (angle between the direction of the air current and the center line of the slider) also varies depending on the radial position on the disk. In designing the slider, therefore, change of the flying amount that depends on the radial disk position must be restrained by suitably utilizing the aforesaid two parameters that vary depending on the radial disk position.

In consideration of the change of the working environment, the disk device is expected to operate smoothly in a low-pressure highland environment. If the magnetic head is constructed in consideration of only the balance between the head load and a positive pressure that acts on the facing surface of the slider based on the air fluid lubrication, the positive pressure that is generated by the air fluid lubrication is lowered in the low-pressure environment. Inevitably, therefore, the slider is balanced in a position where the flying amount is reduced or the slider touches the magnetic disk surface.

Described in Jpn. Pat. Appln. KOKAI Publication No. 2001-283549, for example, is a disk device in which a negative-pressure cavity is formed near the center of a facing surface of a slider in order to prevent the flying amount of the slider from being reduced. The negative-pressure cavity is defined by a groove that is surrounded by projected rails in three other directions than an air outlet direction. The slider is configured to fly on the balance between a negative pressure generated by the negative-pressure cavity, a head load, and a positive pressure. In a low-pressure environment, according to this configuration, the negative pressure is also reduced as the generated positive pressure is reduced. Thus, the slider can be realized having less reduction in flying amount. On the air current outlet end side of the slider, moreover, the negative-pressure cavity is formed having a center pad, and a head portion is provided near the center pad on an outlet side end portion of the slider.

Thus, the flying amount of the slider, flying posture, and reduction of flying amount under a decompressed condition can be adjusted by suitably arranging an irregular shape of the facing surface of the slider. The irregular shape of the facing surface is formed of a groove of a single or several depths.

When the disk device constructed in this manner is in operation, the magnetic head performs a seek operation such that it moves over the surface of a magnetic disk toward a desired track, from the outer periphery side to the inner periphery side or from the inner periphery side to the outer periphery side. With the recent increase of the processing speed, the seek speed of the magnetic head has been increased.

During the seek operation of the magnetic head, however, an air film force that is generated between the magnetic disk surface and the slider fluctuates, so that the flying amount of the slider fluctuates. As the seek speed increases, in particular, the air film force lessens, and the flying amount of the slider is reduced. If the flying behavior of the magnetic head changes in this manner, steady recording and reproduction may possibly fail to be achieved. Thus, the device somewhat lacks in reliability.

### BRIEF SUMMARY OF THE INVENTION

According to an aspect of the invention, there is provided a head comprising: a slider having a facing surface opposed to a surface of a rotatable recording medium and configured to fly by an air current produced between the surface of the recording medium and the facing surface as the recording medium rotates; and a head portion which is provided on the slider and records and reproduces data to and from the recording medium.

The slider has a negative-pressure cavity which is defined by a recess in the facing surface and generates a negative pressure, a leading step portion which protrudes from the facing surface, is situated on the upstream side of the negative-pressure cavity with respect to the air current, and faces the recording medium, and a trailing portion which protrudes from the facing surface, is situated on the downstream side of the negative-pressure cavity with respect to the air current, and faces the recording medium,

the facing surface of the slider having a first direction extending in the direction of the air current, and a second direction perpendicular to the first direction, the trailing portion integrally having a base step portion and a projection which protrudes in the first direction from the base step portion toward the negative-pressure cavity. A proximal end of the projection on the base step portion side has a width smaller than that of the base step portion in the second direction, and a length of the projection in the first direction accounting for about 18% or more of a length of the facing surface in the first direction.

According to another aspect of the invention, there is provided a disk device comprising: a disk-shaped recording medium; a drive unit which supports and rotates the recording medium; a head including a slider, having a facing surface opposed to a surface of the recording medium and configured to fly by an air current produced between the surface of the recording medium and the facing surface as the recording medium rotates, and a head portion which is provided on the slider and records and reproduces data to and from the recording medium; and a head suspension which supports the head for movement with respect to the recording medium and applies a head load directed toward the recording medium surface to the head.

The slider has a negative-pressure cavity which is defined by a recess in the facing surface and generates a negative pressure, a leading step portion which protrudes from the facing surface, is situated on the upstream side of the negative-pressure cavity with respect to the air current, and faces the recording medium, and a trailing portion which protrudes from the facing surface, is situated on the downstream side of the negative-pressure cavity with respect to the air current, and faces the recording medium,

the facing surface of the slider having a first direction extending in the direction of the air current and a second direction perpendicular to the first direction, the trailing portion integrally having a base step portion and a projection which protrudes in the first direction from the base step portion toward the negative-pressure cavity. A proximal end of the projection on the base step portion side has a width smaller than that of the base step portion in the second direction, and a length of the projection in the first direction accounting for about 18% or more of a length of the facing surface in the first direction.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view showing a hard disk drive (hereinafter, referred to as an HDD) according to an embodiment of the invention;

FIG. 2 is an enlarged side view showing a magnetic head portion of the HDD;

FIG. 3 is a perspective view showing the disk-facing surface side of a slider of the magnetic head;

FIG. 4 is a plan view showing the disk-facing surface side of the slider;

FIG. 5 is a sectional view taken along line V-V of FIG. 4;

FIG. 6 is a diagram showing fluctuations of air film forces of the magnetic head according to the embodiment and a prior art example, compared with change of the seek speed;

FIGS. 7A, 7B, 7C, 7D and 7E individually show magnetic head sliders of five types having trailing portions of different shapes;

FIG. 8 is a diagram showing relations between the seek speed and air film force of the magnetic heads of the five types;

FIG. 9 is a diagram showing the rate of fluctuation of the air film force caused by the change of the seek speed, for each of the magnetic heads of the five types;

FIG. 10 is a plan view typically showing relations between a trailing portion and yawed air currents;

FIG. 11 is a diagram showing lift fluctuations of the magnetic head according to the embodiment and the prior art example, compared with change of the seek speed;

FIG. 12 is a plan view showing a slider of a magnetic head according to another embodiment of the invention; and

FIG. 13 is a plan view showing a slider of a magnetic head according to still another embodiment of the invention.

### DETAILED DESCRIPTION OF THE INVENTION

An embodiment in which a disk device according to this invention is applied to a HDD will now be described in detail with reference to the accompanying drawings.

As shown in FIG. 1, the HDD comprises a case 12 in the form of an open-topped rectangular box and a top cover (not shown). The top cover is screwed to the case with screws and closes a top opening of the case.

The case 12 contains a magnetic disk 16 for use as a recording medium, a spindle motor 18, magnetic heads 40, and a carriage assembly 22. The spindle motor 18 serves as a drive unit that supports and rotates the disk 16. The magnetic heads 40 are used to write and read data to and from the disk 16. The carriage assembly 22 supports the magnetic heads 40 for movement with respect to the magnetic disk 16. The case 12 further contains a voice coil motor (hereinafter, referred to as a VCM) 24, a ramp load mechanism 25, a board unit 21, etc. The VCM 24 rotates and positions the carriage assembly 22. The ramp load mechanism 25 holds the magnetic heads 40 in a shunt position off the magnetic disk 16 when the heads 40 are moved to the outermost periphery of the disk. The board unit 21 has a head IC and the like.

A printed circuit board (not shown) for controlling the respective operations of the spindle motor 18, VCM 24, and magnetic heads through the board unit 21 is screwed to the outer surface of a bottom wall of the case 12.

The magnetic disk 16 has magnetic recording layers on its upper and lower surfaces, individually. The disk 16 is fitted on the outer periphery of a hub (not shown) of the spindle motor 18 and fixed on the hub by a clamp spring 17. As the motor 18 is driven, the disk 16 is rotated at a given speed of, e.g., 4,200 rpm, in the direction of arrow B.

The carriage assembly 22 comprises a bearing assembly 26 fixed on the bottom wall of the case 12 and arms 32 that extend from the bearing assembly. These arms 32 are situated parallel to the surface of the magnetic disk 16 and spaced from one another. They extend in the same direction from the bearing assembly 26. The carriage assembly 22 is provided with suspensions 38 that are formed of an elastically deformable elongate plate spring each. The suspensions 38 have their respective proximal ends fixed to the respective distal ends of the arms 32 and extend from the arms. Each suspension 38 may be formed integrally with its corresponding arm 32. The arms 32 and the suspensions 38 constitute a head suspension. The head suspension and the magnetic heads 40 constitute a head suspension assembly.

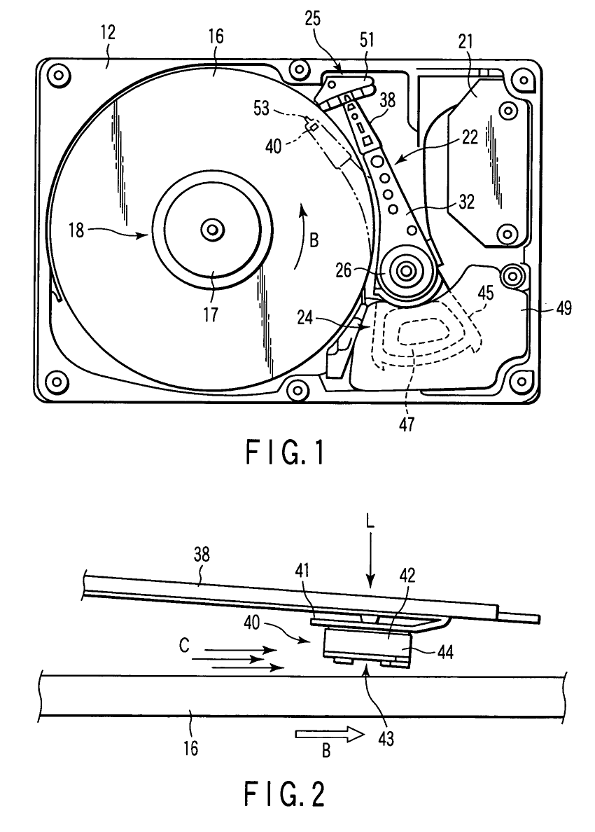

As shown in FIG. 2, each magnetic head 40 has a slider 42 substantially in the shape of a rectangular parallelepiped and a head portion 44 for recording and reproduction on the slider. It is fixed to a gimbals spring 41 that is provided on the distal end portion of the suspension 38. A head load L that is directed toward the surface of the magnetic disk 16 is applied to each magnetic head 40 by the elasticity of the suspension 38.

As shown in FIG. 1, the carriage assembly 22 has a support frame 45 that extends from the bearing assembly 26 in a direction opposite from the arms 32. This support frame 45 supports a voice coil 47 that constitutes a part of the VCM 24. The support frame 45 is molded integrally from synthetic resin on the outer periphery of the coil 47. The voice coil 47 is situated between a pair of yokes 49 that are fixed to the case 12. The coil 47, along with the yokes 49 and a magnet (not shown) fixed to one of the yokes, constitutes the VCM 24. If the voice coil 47 is energized, the carriage assembly 22 rotates around the bearing assembly 26, and each magnetic head 40 is moved to and positioned over a desired track of the magnetic disk 16.

The ramp load mechanism 25 comprises a ramp 51 and a tab 53. The ramp 51 is provided on the bottom wall of the case 12 and located outside the magnetic disk 16. The tab 53 extends from the distal end of each suspension 38. As the carriage assembly 22 rotates to a shunt position outside the magnetic disk 16, each tab 53 engages a ramp surface formed on the ramp 51. Thereafter, the tab 53 is pulled up by the inclination of the ramp surface, whereby the magnetic heads 40 are unloaded.

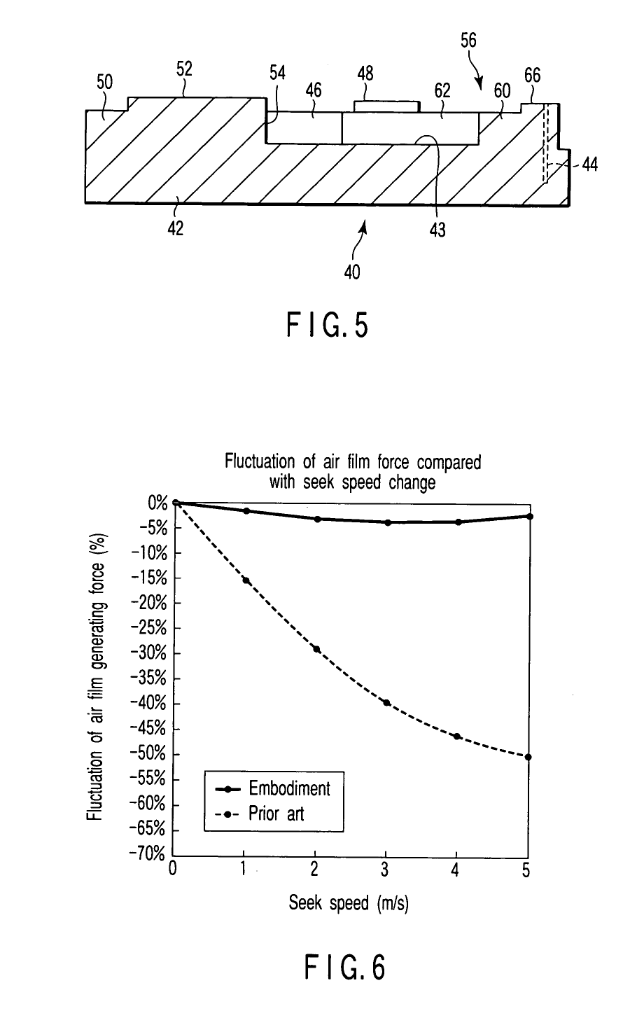

The following is a detailed description of the construction of each magnetic head 40. As shown in FIGS. 2 to 5, the magnetic head 40 has the slider 42 substantially in the shape of a rectangular parallele-piped. The slider 42 has a rectangular disk-facing surface 43 that faces a surface of the magnetic disk 16. The longitudinal direction of the disk-facing surface 43 will be given by a first direction X, and its transverse direction perpendicular to the first direction X by a second direction Y.

The magnetic head 40 is constructed as a flying slider. The slider 42 flies by an air current C that is produced between the disk surface and the disk-facing surface 43 as the magnetic disk 16 rotates. During the operation of the HDD, the disk-facing surface 43 of the slider 42 never fails to face the disk surface with a gap between the surfaces. The direction of the air current C is coincident with a rotation direction B of the magnetic disk 16. The slider 42 is located with respect to the surface of the magnetic disk 16 so that the first direction X of the disk-facing surface 43 is substantially coincident with the direction of the air current C.

A leading step portion 50 that faces the magnetic disk surface protrudes from the disk-facing surface 43. It is substantially in the shape of a U that is closed on the upstream side and opens on the downstream side. In order to maintain the pitch angle of the magnetic head 40, a leading pad 52 is formed projecting on the leading step portion 50. It forms an air film that supports the slider 42. The leading pad 52 is formed having an elongate shape that continuously extends in the second direction Y, and is situated on the inlet end side of the slider 42 with respect to the air current C.

The leading step portion 50 has a pair of rail step portions 46 that extend individually along the long sides of the disk-facing surface 43 and are opposed to each other with a space. The rail step portions 46 extend from the leading pad 52 toward a downstream end of the slider 42. A side pad 48 is formed on each rail step portion 46 and faces the magnetic disk surface.

A negative-pressure cavity 54 is formed in a substantially central part of the disk-facing surface 43. It is formed of a recess that is defined by the rail step portions 46 and the leading step portion 50. The cavity 54 is formed on the downstream side of the leading step portion 50 with respect to the direction of the air current C and opens on the downstream side. The negative-pressure cavity 54 serves to generate a negative pressure in the central part of the disk-facing surface 43 for all skew angles that can be realized in the HDD.

The slider 42 has a trailing portion 56 facing the magnetic disk surface that protrudes from a downstream-side end portion of the disk-facing surface 43 with respect to the direction of the air current C. The trailing portion 56 is situated on the downstream side of the negative-pressure cavity 54 with respect to the direction of the air current C and substantially in the center of the disk-facing surface 43 with respect to the transverse direction.

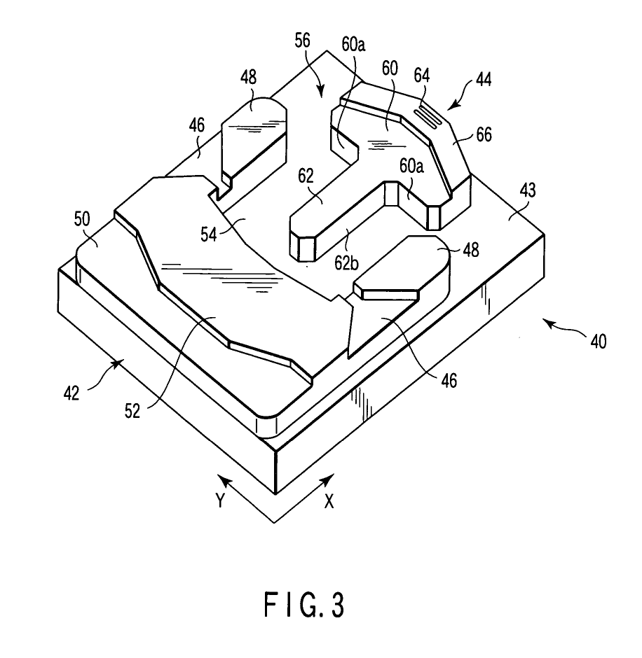

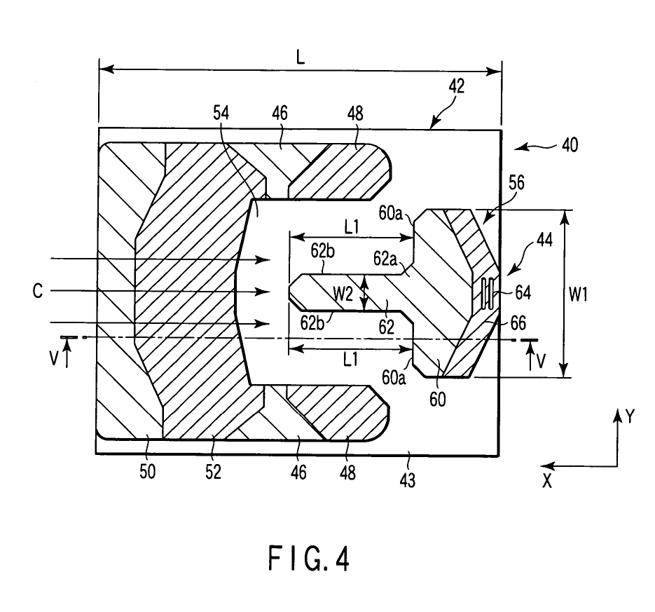

As shown in FIGS. 3 to 5, the trailing portion 56 is provided integrally with a substantially rectangular base step portion 60 and an extending portion 62 that extends from the base step portion toward an inlet end of the disk-facing surface 43. The base step portion 60 has a given width in the first direction X and is provided on the outlet end side of the disk-facing surface 43. In the present embodiment, the base step portion 60 is provided in a substantially central part of the disk-facing surface 43 in the second direction Y. A trailing pad 66 is formed on a downstream-side end portion of the base step portion 60 and faces the surface of the magnetic disk 16. In FIG. 4, the individual parts are hatched differently so that the differences between the heights of the individual parts of the disk-facing surface 43 are clearly understood.

The projection 62 protrudes substantially from the center of the base step portion 60. In the second direction Y, a proximal end 62a of the projection 62 on the base step portion side is formed having a width smaller than that of the base step portion 60. Thus, the base step portion 60 has proximal end faces 60a that extend in the second direction Y and face the inlet end side of the slider 42. These proximal end faces are situated on either side of the projection 62 with respect to the second direction Y. A width W2 of the projection 62 in the second direction Y accounts for 3 to 97% of a width W1 of the base step portion 60, and preferably for 15 to 70%.

The projection 62 has a pair of side faces 62b that extend substantially parallel to the first direction X. A length L1 of the projection 62 in the first direction X is formed accounting for about 18% or more of a length L of the disk-facing surface 43 in the first direction X, and preferably for 25% or more.

As shown in FIGS. 3 to 5, the head portion 44 of each magnetic head 40 has a recording element and a reproducing element that record and reproduce data to and from the magnetic disk 16, respectively. The recording and reproducing elements are embedded in a downstream-side end portion of the slider 42 with respect to the direction of the air current C. The recording and reproducing elements have read/write gaps 64 defined in the trailing pad 66.

As shown in FIG. 2, the magnetic head 40 having the above-described construction flies in an inclined posture such that the read/write gaps 64 of the head portion 44 are situated closest to the disk surface.

According to the HDD and the head suspension assembly constructed in this manner, the magnetic head 40 flies by the air current C that is produced between the disk surface and the disk-facing surface 43 as the magnetic disk 16 rotates. Thus, during the operation of the HDD, the disk-facing surface 43 of the slider 42 never fails to face the disk surface with the gap between them. According to the magnetic head 40 constructed in this manner, moreover, the trailing portion 56 has the projection 62 that protrudes from the base step portion 60. Even in high-speed seek operation, therefore, fluctuation of the flying amount can be restrained, so that the safety and reliability can be improved.

For the HDD according to the present embodiment and the prior art HDD, fluctuation of the force of the air film is simulated with the seek speed of the magnetic head 40 varied. In a conventional magnetic head in which a trailing portion is not provided with a projection, as indicated by broken line in FIG. 6, the air film force that is generated in a given flying posture lowers to 50% if the seek speed reaches a high speed of 5 ms. According to the magnetic head 40 of the present embodiment, as indicated by full line in FIG. 6, on the other hand, the reduction of the air film force can be restricted to 2% even when the seek speed reaches 5 ms.

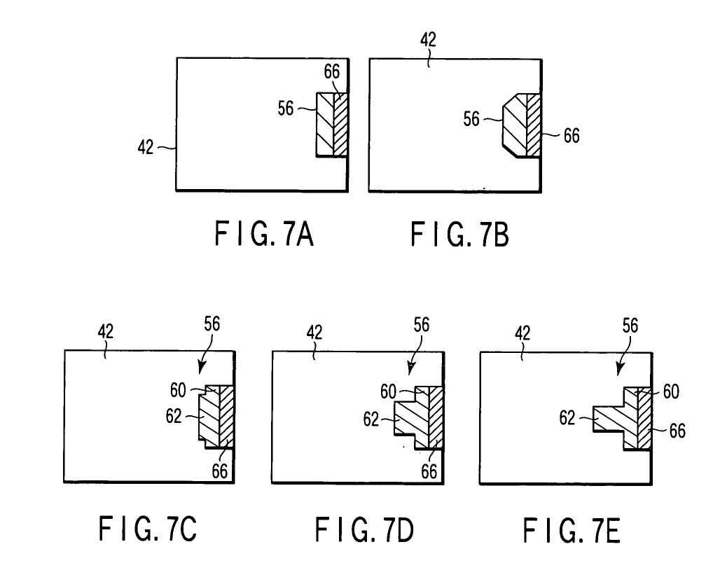

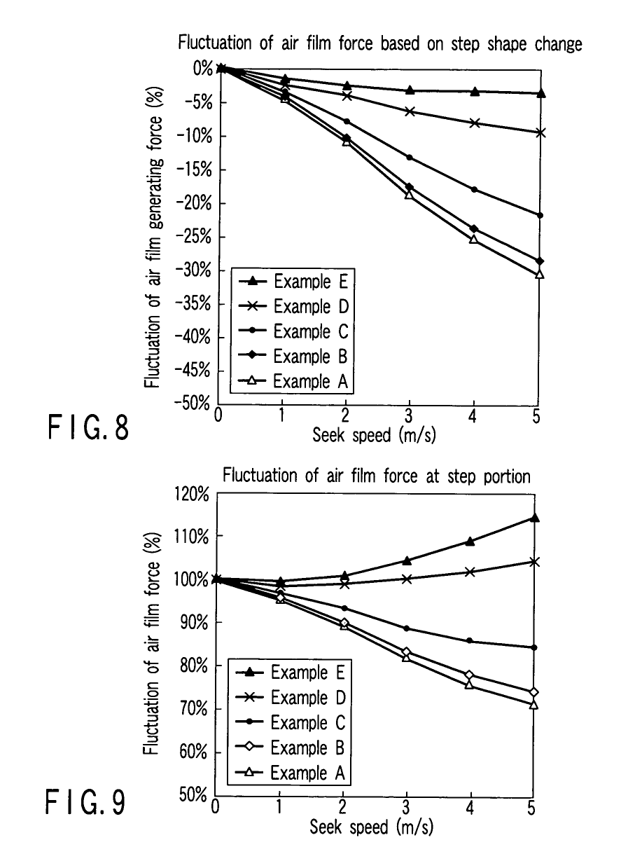

In order to analyze the reason why the reduction of the air film force can be restrained, the inventors hereof prepared magnetic heads having various trailing portions of different shapes, e.g., magnetic heads A, B, C, D and E of five types, as shown in FIGS. 7A to 7E, and compared fluctuations of their air film forces that were caused as the seek speed increased. FIG. 8 shows the results of the comparison. The five magnetic heads shared the area of the trailing portion of the slider, the area of the trailing pad 66, and the depth of the negative-pressure cavity, and were different only in the shape of the trailing portion. By way of example, the depths of the negative-pressure cavity and the trailing step were adjusted to 1 μm and 0.12 μm, respectively.

Neither of the magnetic heads A and B has a projection. The magnetic heads C, D and E, like the one according to the present embodiment, have their projections of different lengths.

In the cases of the magnetic heads A and B that have no projection, as shown in FIG. 8, the lowering rate of the air film force based on the increase of the seek speed ranged from 20 to 30%. On the other hand, the magnetic heads C and D were provided with the projection 62 extending in the first direction X of the slider, whereby an effect to restrain the reduction of the air film force started to be observed. When the length of the projection 62 accounted for about 18% of the overall length of the slider, as in the magnetic head E, the reduction of the air film force was found to be 3%, indicating a substantial improvement.

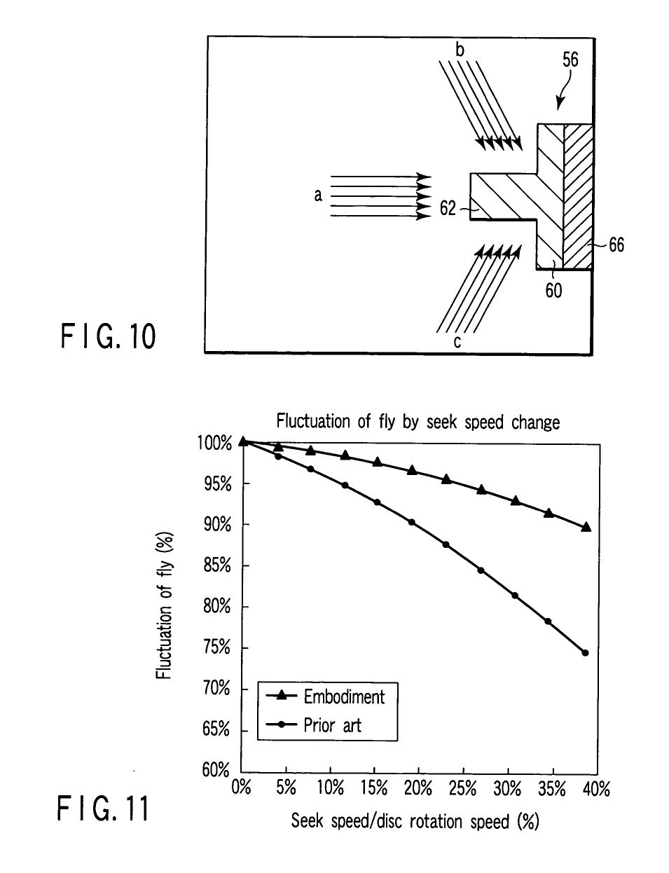

FIG. 9 shows the rate of fluctuation of the air film force caused by the change of the seek speed, for the shape of the trailing portion of each magnetic head. It indicates that the reduction of the air film force during the seek operation is restrained if the trailing portion is provided with the projection 62, and that the air film force is rather enhanced with the increase of the seek speed if the height of the projection is increased. This is because the efficiency of generation of the air film force can be enhanced by receiving yawed air currents b and c by the projection 62 during the seek operation, as shown in FIG. 10.

FIG. 11 shows results of simulation of seek-time fluctuations in the magnetic head lift for the magnetic head according to the present embodiment and a conventional magnetic head. In FIG. 11, the axis of abscissa represents the ratio of the seek speed to the rotational speed of the magnetic disk. The magnetic head of the present embodiment and the conventional magnetic head share the shapes and sizes of the leading step portion and the negative-pressure cavity, and are different only in the shape of the trailing portion. According to the magnetic head of the present embodiment, the fluctuation of the flying amount of the magnetic head relative to the change of the seek speed is found to be much less than that of the prior art example.

According to the magnetic head of the present embodiment, the head suspension assembly provided with the same, and HDD, as described above, the fluctuation of the flying amount of the head can be restrained to ensure steady recording and reproduction even in high-speed seek operation. Also, the magnetic head and the magnetic disk can be prevented from running against each other, so that the reliability can be improved.

This invention is not limited directly to the embodiment described above, and its components may be embodied in modified forms without departing from the scope or spirit of the invention. Further, various inventions may be made by suitably combining a plurality of components described in connection with the foregoing embodiments. For example, some of the components according to the foregoing embodiments may be omitted. Furthermore, components according to different embodiments may be combined as required.

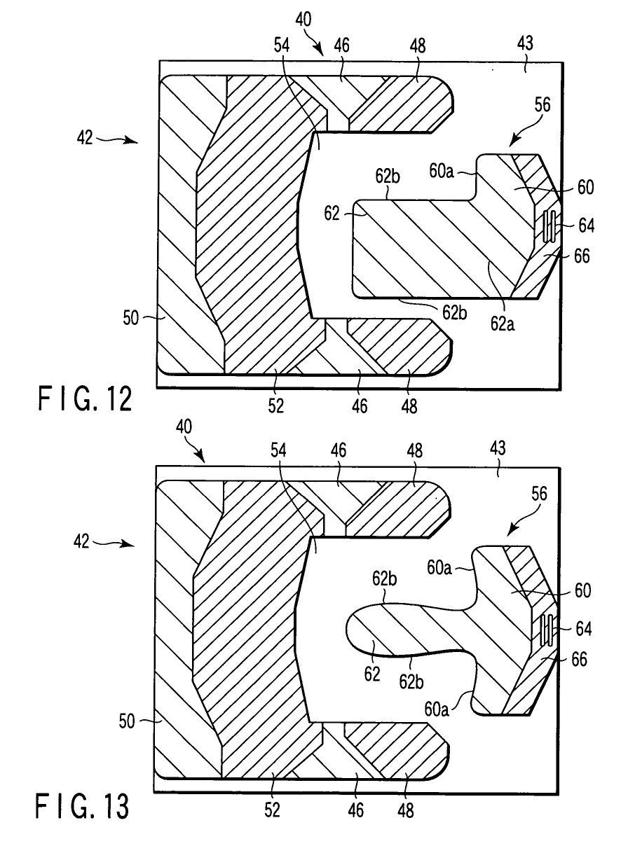

The shapes and sizes of the leading step portion, trailing portion, and pads are not limited to those of the embodiment described above, but may be varied as required. The location of the projection 62 of the trailing portion 56 is not limited to the central part of the base step portion 60. Alternatively, as shown in FIG. 12, for example, it may be located eccentrically to the base step portion 60 with respect to the second direction Y. In this case, one of the side faces 62b of the projection 62 extends flush with a side face of the base step portion 60. A proximal end face 60a of the base step portion 60 is situated only on one side of the projection 62 with respect to the second direction Y.

The proximal end faces 60a of the base step portion 60 and the side faces 62b of the projection 62 are not limited to straight lines, but may be formed into curved shapes, as shown in FIG. 13, for example.

The embodiments shown in FIGS. 12 and 13 share other configurations with the foregoing embodiment. Therefore, like reference numerals are used to designate like portions of these embodiments, and a detailed description of those portions is omitted. The same functions and effects of the foregoing embodiment can be obtained from these alternative embodiments. In FIGS. 13 and 14, individual parts of the disk-facing surface 43 are differently hatched to make differences in level between them clear.

What is claimed is:

1. A head comprising:
a slider having a facing surface opposed to a surface of a rotatable recording medium and configured to fly by an air current produced between the surface of the recording medium and the facing surface as the recording medium rotates; and
a head portion which is provided on the slider and records and reproduces data to and from the recording medium,
the slider having a negative-pressure cavity which is defined by a recess in the facing surface and generates a negative pressure, a leading step portion which protrudes from the facing surface, is situated on the upstream side of the negative-pressure cavity with respect to the air current, and faces the recording medium, and a trailing portion which protrudes from the facing surface, is situated on the downstream side of the negative-pressure cavity with respect to the air current, and faces the recording medium,
the facing surface of the slider having a first direction extending in the direction of the air current, and a second direction perpendicular to the first direction, the trailing portion integrally having a base step portion and a projection which protrudes in the first direction from the base step portion toward the negative-pressure cavity, and
a proximal end of the projection on the base step portion side having a width smaller than that of the base step portion in the second direction, and a length of the projection in the first direction accounting for about 18% or more of a length of the facing surface in the first direction.

2. The head according to claim 1, wherein the width of the projection in the second direction accounts for 3 to 97% of the width of the base step portion.

3. The head according to claim 1, wherein the base step portion has proximal end faces which extend in the second direction and face the negative-pressure cavity of the slider, the proximal end faces being situated on either side of the projection with respect to the second direction.

4. The head according to claim 1, wherein the base step portion has a proximal end face which extends in the second direction and faces the negative-pressure cavity of the slider, the proximal end face being situated only on one side of the projection with respect to the second direction.

5. The head according to claim 1, wherein the projection has a pair of side faces which extend substantially parallel to the first direction.

6. The head according to claim 1, wherein the slider has a pair of rail step portions which extend from the leading step portion toward a downstream end of the slider and protrude from the facing surface so as to surround the negative-pressure cavity.

7. A head suspension assembly used in a disk device including a disk-shaped recording medium and a drive unit which supports and rotates the recording medium, the head suspension assembly comprising:
a head including a slider, having a facing surface opposed to a surface of the recording medium and configured to fly by an air current produced between the surface of the recording medium and the facing surface as the recording medium rotates, and
a head portion which is provided on the slider and records and reproduces data to and from the recording medium; and
a head suspension which supports the head for movement with respect to the recording medium and applies a head load directed toward the recording medium surface to the head,
the slider having a negative-pressure cavity which is defined by a recess in the facing surface and generates a negative pressure, a leading step portion which protrudes from the facing surface, is situated on the upstream side of the negative-pressure cavity with respect to the air current, and faces the recording medium, and a trailing portion which protrudes from the facing surface, is situated on the downstream side of the negative-pressure cavity with respect to the air current, and faces the recording medium,
the facing surface of the slider having a first direction extending in the direction of the air current and a second direction perpendicular to the first direction, the trailing portion integrally having a base step portion and a projection which protrudes in the first direction from the base step portion toward the negative-pressure cavity, and
a proximal end of the projection on the base step portion side having a width smaller than that of the base step portion in the second direction, and a length of the projection in the first direction accounting for about 18% or more of a length of the facing surface in the first direction.

8. The head suspension assembly according to claim 7, wherein the width of the projection in the second direction accounts for 3 to 97% of the width of the base step portion.

9. A disk device comprising:
a disk-shaped recording medium;
a drive unit which supports and rotates the recording medium;
a head including a slider, having a facing surface opposed to a surface of the recording medium and configured to fly by an air current produced between the surface of the recording medium and the facing surface as the recording medium rotates, and a head portion which is provided on the slider and records and reproduces data to and from the recording medium; and
a head suspension which supports the head for movement with respect to the recording medium and applies a head load directed toward the recording medium surface to the head,
the slider having a negative-pressure cavity which is defined by a recess in the facing surface and generates a negative pressure, a leading step portion which protrudes from the facing surface, is situated on the upstream side of the negative-pressure cavity with respect to the air current, and faces the recording medium, and a trailing portion which protrudes from the facing surface, is situated on the downstream side of the negative-pressure cavity with respect to the air current, and faces the recording medium,
the facing surface of the slider having a first direction extending in the direction of the air current and a second direction perpendicular to the first direction, the trailing portion integrally having a base step portion and a projection which protrudes in the first direction from the base step portion toward the negative-pressure cavity, and
a proximal end of the projection on the base step portion side having a width smaller than that of the base step portion in the second direction, and a length of the projection in the first direction accounting for about 18% or more of a length of the facing surface in the first direction.

10. The disk device according to claim 9, wherein the width of the projection in the second direction accounts for 3 to 97% of the width of the base step portion.
